(19) United States
(12) Patent Application Publication
(10) Pub. No.: US 2003/0030885 A1
(43) Pub. Date: Feb. 13, 2003

(54) Spatial light modulation array, method for manufacturing the same, and laser display device using the spatial light modulation

(75) Inventors: Hyun-Ho Oh, Anyang (KR); Jong-Uk Bu, Seonganam (KR); Don-Hee Lee, Anyang (KR)

Correspondence Address: MORGAN LEWIS & BOCKIUS LLP, 1111 PENNSYLVANIA AVENUE NW, WASHINGTON, DC, 20004, US

(73) Assignee: LG Electronics Inc.

(21) Appl. No.: 10/157,463

(22) Filed: May 30, 2002

(30) Foreign Application Priority Data
Aug. 7, 2001 (KR) 47467/2001

(51) Int. Cl. C09K 19/02; G02F 1/29; G02B 26/08

(52) U.S. Cl. 359/301

(57) ABSTRACT

A spatial light modulation array, which is capable of controlling the diffraction characteristic of light in each portion in a substrate, a method for manufacturing the same, and a laser display device, which is capable of displaying an image regardless of mechanical reliability using the spatial light modulator in the form of an array are provided. The laser display device includes a lens for converting a laser beam oscillated by a light source into a one-dimensional slit beam, a spatial light modulation array for determining the diffraction degree of the slit beam according to the voltage applied to the pixel electrodes, diffracting the slit beam, and delivering the slit beam, a blocking portion for selectively transmitting the diffracted beam, a condensing lens for condensing the selectively transmitted beam, and a scanner for scanning the condensed beam to a screen.

### BACKGROUND OF THE INVENTION

1. Field of the Invention

The present invention relates to a laser display device, and more particularly, to a spatial light modulation array, which is capable of displaying an image by modulating laser light, a method for manufacturing the same, and a laser display device using the spatial light modulation array.

2. Description of the Background Art

In general, optical signal processing has advantages such as high speed, parallel processing ability, and large amount of information processing unlike conventional digital information processing, which is not capable of processing a large amount data in real time. Researches in the design and the fabrication of a binary phase filter, an optical logic gate, a light amplifier, an image processing method, a optical element, and a light modulator are performed using a spatial light modulation theory. A spatial light modulator is used in fields such as an optical memory, light interconnection, and a hologram. Research and development in a display device using the spatial light modulator are performed.

In the spatial light modulator, a Bragg gating is formed in a piezoelectric material and a path difference is generated by diffracting the light incident according to the period of the Bragg gating. The conventional spatial light modulator using the Bragg grating is divided into a spatial light modulator using an acoustooptic effect and a spatial light modulator using magnetism. The spatial light modulator using the acoustooptic effect according to a conventional technology will now be described with reference to FIG. 1.

FIG. 1 is a schematic view showing a spatial light modulator using the acoustooptic effect according to the conventional technology.

As shown in FIG. 1, the spatial light modulator using the acoustooptic effect according to the conventional technology includes a piezoelectric material substrate 1 and a transducer 2 attached to one surface of the piezoelectric material 1, the transducer 2 for converting applied electrical energy into sound energy and generating acoustic wave to the other surface that faces the above surface of the piezoelectric material substrate 1, to thus generate the Bragg gating in the piezoelectric material substrate 1.

The spatial light modulator using the acoustooptic effect according to the conventional technology will now be described.

The transducer 2 is attached to one surface of the piezoelectric material substrate 1. When a voltage is applied to the transducer 2, the transducer 2 converts the applied electrical energy into the sound energy.

The sound energy is in the form of the acoustic wave that proceeds from one surface of the piezoelectric material substrate 1, to which the transducer 2 is attached, to the other surface of the piezoelectric material substrate 1, which faces the above surface. The Bragg grating is formed in the piezoelectric material substrate 1 due to the proceeding of the acoustic wave. The grating period of the Bragg grating varies according to the electrical energy applied to the transducer 2.

When laser light is irradiated to the piezoelectric material substrate 1 in a direction perpendicular to the direction, in which the acoustic wave proceeds, light is diffracted at an angle that is inverse proportionate to the period of the Bragg grating. A phenomenon, in which the light is diffracted through the Bragg grating, is referred to as the Bragg diffraction.

In the spatial light modulator using the acoustooptic effect, when the frequency of the applied voltage is changed, the frequency of the acoustic wave generated by the transducer 2 is changed. Accordingly, the period of the Brag grating generated in the piezoelectric material substrate 1 change. Therefore, the diffraction angle of the light incident on the piezoelectric material substrate 1 changes. Also, the strength of the acoustic wave changes according to the strength of the voltage applied to the transducer 2. At this time, the diffraction efficiency of the diffracted light changes. According to the spatial optical modulator that diffracts light using the above principle, the generated acoustic wave cannot proceed only in the desired region. The generated acoustic wave proceeds in a uniform direction in the entire region of the piezoelectric material substrate 1. Therefore, it is not possible to form the spatial light modulator in the form of an array.

FIG. 2 is a block diagram of the laser display device according to the conventional technology.

As shown in FIG. 2, the laser display device includes spatial light modulators 21 through 23 for respectively receiving red, green, and blue (RGB) laser lights, modulating a certain amount of laser lights, and outputting the modulated laser lights, reflecting mirrors 24 through 26 for reflecting the laser lights modulated by the respective spatial light modulators 21 through 23, a scanning portion 27 for changing the positions of the reflecting mirrors 24 through 26, and a condensing lens 28 for displaying the laser lights reflected by the reflecting lenses 24 through 26 on a screen.

The operation of the laser display device according to the conventional technology will now be described in detail.

The lights oscillated by the red, green, and blue lasers of short wavelengths are modulated by the spatial light modulators 21 through 23 using the acoustooptic effect. At this time, the intensities of the respective modulated short wavelength laser lights are controlled according to the screen, on which the laser lights are to be displayed. The three short wavelengths form a pixel. The brightness and the color of a desired pixel are determined according to the amount of the modulated laser lights.

The laser lights modulated by the spatial light modulators 21 through 23 are reflected by the reflecting mirrors 24 through 26 respectively corresponding to the spatial light modulators 21 through 23 and are displayed on the screen through the condensing lens 28. The displayed laser lights (images) are scanned on the screen by the scanning portion 27 for controlling the angles of the reflecting mirrors 24 through 26. This is how images are displayed.

The laser display device can display a video image to the maximum six hundred inches and can display the video image on a large screen of high visibility and high picture quality due to long-distance projection ability peculiar to laser and the high-density characteristic of a laser beam. In the laser display device, a color-realizing region is very large. However, the laser display device is not put to practical use because the miniaturization of a light source and the development of an appropriate light modulator are not completed.

Also, a system becomes larger and more expensive because a light modulator having a small diffraction angle is used. The operation of the scanning portion 27 for driving the reflecting mirrors 24 through 26 is mechanical. The reliability of this operation is low.

As mentioned above, in the spatial light modulator according to the conventional technology, it is not possible to restrict the acoustic wave to proceed only in a specific region and to thus form the array because the light is modulated using the acoustic wave. The characteristic of a system deteriorates when the spatial light modulator is applied to the system because the diffraction angle of the spatial light modulator is relatively small.

In the laser display device using the spatial light modulator, according to the conventional technology, the red, green, and blue laser lights are modulated using the spatial light modulator. The modulated laser lights are reflected by a plurality of reflecting mirrors that can change reflection angles and are displayed on the screen through the condensing lens. Accordingly, the size of a system becomes relatively larger due to the characteristic, where the diffraction angle of the spatial light modulator using the acoustic wave having a small diffraction angle is small.

In the laser display device using the spatial light modulator according to the conventional technology, it is not possible to correctly display the laser lights on the screen because the mechanical reliability of an apparatus for changing the reflection angles of the reflecting mirrors deteriorates.

### SUMMARY OF THE INVENTION

Therefore, an object of the present invention is to provide a spatial light modulation array, which is capable of controlling the diffraction characteristic of light in each portion of a substrate, a method for manufacturing the same, and a laser display device for displaying images regardless of mechanical reliability using a spatial light modulator in the form of an array.

To achieve these and other advantages and in accordance with the purpose of the present invention, as embodied and broadly described herein, there is provided a spatial light modulation array, comprising a ferroelectric substrate divided into a plurality of polarization regions and a plurality of electrodes formed on the upper surface and the lower surface of the plurality of polarization regions.

There is provided a method for manufacturing a spatial light array, comprising the steps of forming a plurality of electrodes on the upper surface and the lower surface of a ferroelectric substrate, in which spontaneous polarization is formed, such that the electrodes formed on the upper surface of the ferroelectric substrate face the electrodes formed on the lower surface of the ferroelectric substrate, applying a voltage to the plurality of electrodes and reversing the polarization of the ferroelectric substrate contacting the electrodes, and removing the electrodes and forming a plurality of electrodes on the upper surface and the lower surface of the ferroelectric substrate such that the electrodes formed on the upper surface of the ferroelectric substrate face the electrodes formed on the lower surface of the ferroelectric substrate.

There is provided a laser display device, comprising a lens for converting a laser beam oscillated by a light source into a one-dimensional slit beam, a spatial light modulation array for determining the diffraction degree of the slit beam according to the voltage applied to the pixel electrodes, diffracting the slit beam, and delivering the slit beam, a blocking portion for selectively transmitting the diffracted beam, a condensing lens for condensing the selectively transmitted beam, and a scanner for scanning the condensed beam to a screen.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing a spatial light modulator using an acoustooptic effect according to a conventional technology;

FIG. 2 is a block diagram of a laser display device according to the conventional technology;

FIGS. 3A through 3C are schematic sectional view showing the principle of spontaneous polarization according to the present invention;

FIGS. 4A through 4C are sectional view showing the order of a method for manufacturing a spatial light modulation array according to the present invention;

FIG. 5 is a perspective view showing the structure and the operation of the spatial light modulation array according to the present invention;

FIG. 6 is a graph showing the distribution of the refractive indices of light delivered after a voltage is applied to the respective electrodes Pₖ₋₁, Pₖ, and Pₖ₊₁ shown in FIG. 5; and

FIG. 7 is a block diagram showing a laser display device using the spatial light modulation array according to the present invention.

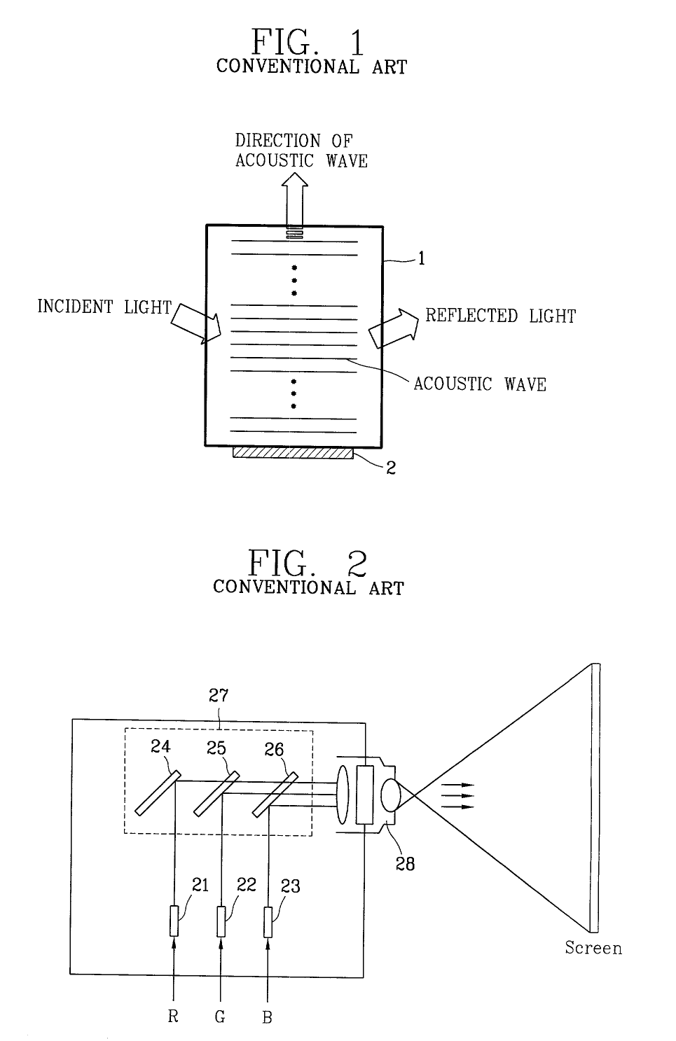

### DETAILED DESCRIPTION OF THE PREFERRED EMBODIMENTS

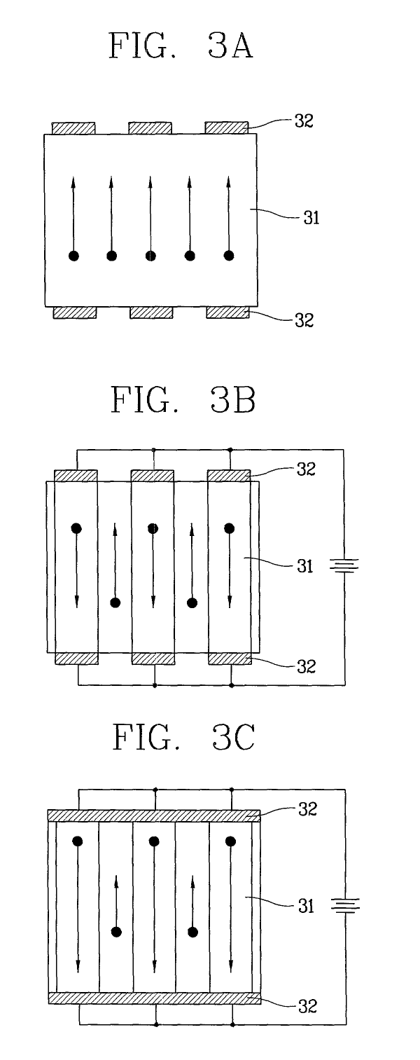

Preferred embodiments of a spatial light modulation array according to the present invention, a method for manufacturing the same, and a laser display device using the spatial light modulation array will now be described in detail with reference to FIGS. 3 through 7.

FIGS. 3A through 3C are schematic sectional views showing the principle of spontaneous polarization according to the present invention.

As shown in FIGS. 3A through 3C, the principle of the spontaneous polarization according to the present invention includes the steps of repeatedly forming electrodes 32 corresponding to the upper surface and the lower surface of a ferroelectric substrate 31 having the spontaneous polarization at the temperature no more than the Curie temperature such that the widths of the electrodes 32 are equal to each other and that the distances, by which the respective electrodes 32 are separated from each other, are equal to each other (FIG. 3A), of polarization reversing the spontaneous polarization of the ferroelectric substrate 31 in the position, where the electrodes 32 are formed, by applying a voltage to the electrodes 32, thus applying an electric field to the ferroelectric substrate 31 (FIG. 3B), and of removing the electrodes 32 and forming electrodes 33 on the upper surface and the lower surface of the ferroelectric substrate 31 (FIG. 3C). Polarization reversal is a state, where the direction of the initial polarization that is spontaneously formed is forcibly rotated to the opposite direction, that is, at an angle of 180 degrees and is fixed.

The principle of the spontaneous polarization according to the present invention will now be described in detail.

In general, a ferroelectric substance has the spontaneous polarization at the temperature no more than the Curie temperature. The spontaneous polarization can be reversed by an electric field. As shown in FIG. 3B, when the periodical electrode patterns 32 are formed and the voltage is applied to the electrodes 32, domain inversion opposite to the spontaneous polarization occurs in the region of the ferroelectric substrate 31 corresponding to the region of the electrodes 32. The domain is generated because a depolarization field is formed due to the arrangement of an electric dipole and is divided into a 90° region and a 180° region. At this time, regions, where the directions of the polarization are different from each other, can be periodically formed in the ferroelectric substrate 31.

When light is irradiated to the region perpendicular to the polarization direction, the light goes straight and is transmitted because there is no change in the refractive indices. When the electrodes 32 are removed, the electrodes 33 are formed on the upper surface and the lower surface of the ferroelectric substrate 31, the voltage is applied to the electrodes 33, and an electric field is applied to the ferroelectric substrate 31, the refractive indices of the respective polarization regions of the ferroelectric substrate 31 become linear in proportion to the electric field. That is, a linear electrooptic effect in the region, where the spontaneous polarization is formed, occurs in a direction opposite to the direction, where the linear electrooptic effect occurs in a domain-inverted region. Therefore, it is possible to form the Bragg grating, where the refractive indices periodically distribute due to the application of the electric field, in the respective polarization regions of the ferroelectric substrate 31.

When light is incident in a direction perpendicular to the electric field in a state, where the voltage is applied to the electrodes 33 and the electric field is applied to the ferroelectric substrate 31, the light is diffracted at an angle inverse proportionate to the period of the grating. When the electric field is removed, the light goes straight without being diffracted and is directly transmitted.

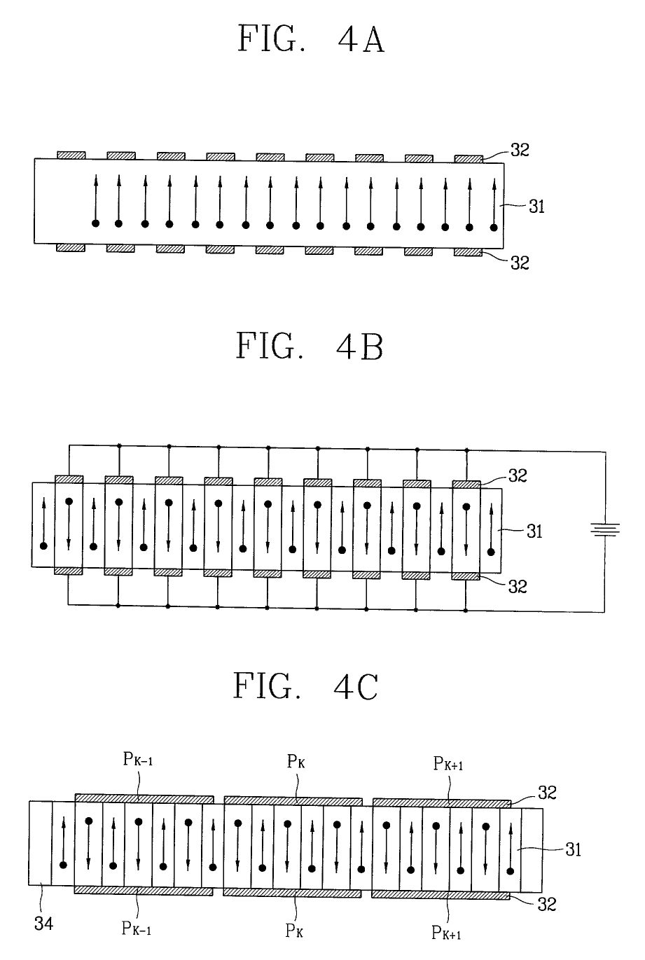

The structure and the fabrication method of the spatial light modulation array according to the present invention using the above principle will now be described in detail with reference to FIGS. 4A through 4C.

FIGS. 4A through 4C are sectional views showing the order of the method for manufacturing the spatial light modulation array according to the present invention.

As shown in FIGS. 4A through 4C, the method for manufacturing the spatial light modulation array according to the present invention includes the steps of forming the plurality of electrodes 32 on the upper surface and the lower surface of the ferroelectric substrate 31, in which the spontaneous polarization is formed in a uniform direction, such that the electrodes 32 formed on the upper surface of the ferroelectric substrate 31 correspond to the electrodes 32 formed on the lower surface of the ferroelectric substrate 31, that the widths of the electrodes 32 are equal to each other, and that the distances, by which the electrodes 32 are separated from each other, are equal to each other (FIG. 4A), reversing the polarization direction of the ferroelectric substrate 31 in the parts, where the electrodes 32 are positioned, by applying the voltage to the electrodes 32 (FIG. 4B), and removing the electrodes 32 and forming electrodes Pₖ₋₁, Pₖ, and Pₖ₊₁, to which the voltage can be independently applied, on the upper surface and the lower surface of the ferroelectric substrate 31 such that the electrodes Pₖ₋₁, Pₖ, and Pₖ₊₁, formed on the upper surface of the ferroelectric substrate 31 face the electrodes Pₖ₋₁, Pₖ, and Pₖ₊₁ formed on the lower surface of the ferroelectric substrate 31 (FIG. 4C).

The method for manufacturing the spatial light modulation array according to the present invention will now be described in detail.

A metal is deposited on the upper surface and the lower surface of the ferroelectric substrate 31 having the spontaneous polarization that precedes from the lower surface to the upper surface at the temperature no more than the Curie temperature. The plurality of electrodes (pixel electrodes) 32 are formed on the upper surface and the lower surface of the ferroelectric substrate 31 such that the electrodes 32 formed on the upper surface of the ferroelectric substrate 31 face the electrodes 32 formed on the lower surface of the ferroelectric substrate 31 by patterning the deposited metal. At this time, the plurality of electrodes 32 are formed such that the widths and the lengths of the electrodes 32 are equal to each other and that the distances, by which the electrodes 32 are separated from each other, are equal to each other.

As shown in FIG. 4B, the voltage is applied to the plurality of electrodes 32. At this time, the direction, in which the voltage is applied, is opposite to the polarization direction in the ferroelectric substrate 31. A positive (+) voltage is applied to the upper surface of the ferroelectric substrate 31 and the lower surface of the ferroelectric substrate 31 is grounded so that the electric field is formed in the ferroelectric substrate 31.

The electric field is formed in the region of the ferroelectric substrate 31, which faces the region, in which the electrodes 32 are positioned, due to the voltage applied to the electrodes 32. The direction of the spontaneous polarization is reversed due to the electric field.

As shown in FIG. 4C, the electrodes (pixel electrodes) Pₖ₋₁, Pₖ, and Pₖ₊₁ are formed by depositing the metal on the upper surface and the lower surface of the ferroelectric substrate 31 and patterning the deposited metal after selectively removing the electrodes 32.

A reflection less layer 34 is formed by polishing the surface, on which the light is incident and from which the light is delivered, in the ferroelectric substrate 31 and depositing a dielectric layer on the polished surface. It is possible to selectively determine the diffraction degree of the light by applying the same electric field to the Bragg grating regions positioned under the respective electrode regions Pₖ₋₁, Pₖ, and Pₖ₊₁ due to the formation of the electrodes Pₖ₋₁, Pₖ, and Pₖ₊₁. Accordingly, it is possible to deliver the light having the desired wavelength.

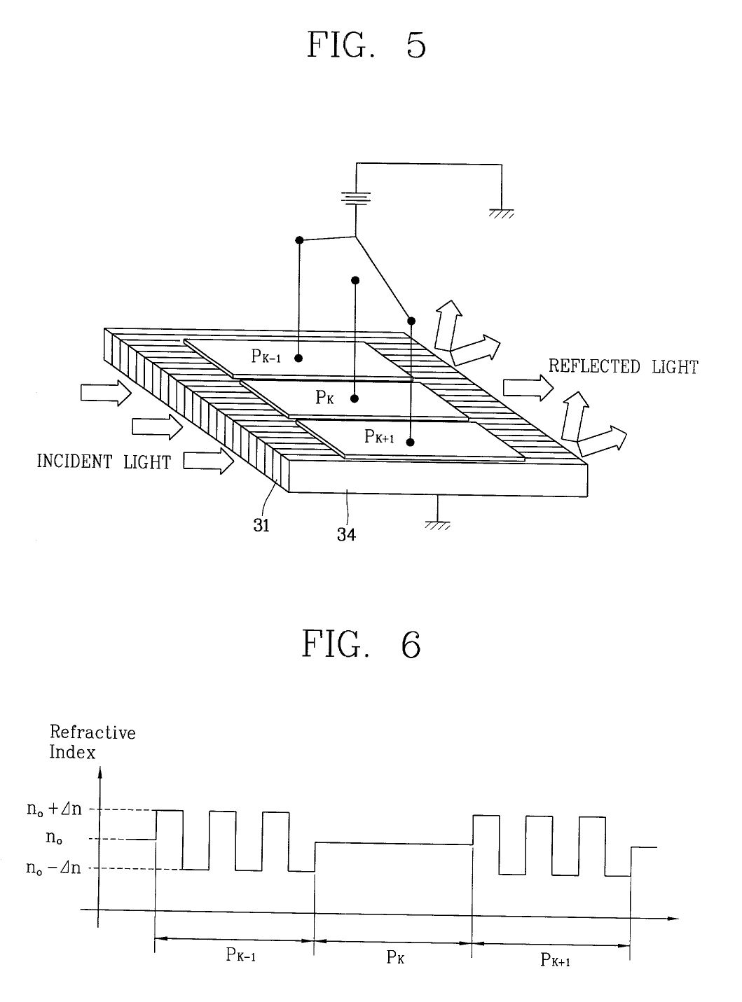

FIG. 5 is a perspective view showing the structure and the operation of the spatial light modulation array according to the present invention. That is, FIG. 5 is a perspective view showing the structure and the operation of the spatial light modulation array manufactured by the above processes.

As shown in FIG. 5, the spatial light modulation array according to the present invention is divided into the plurality of Bragg grating regions. The spatial light modulation array includes the ferroelectric substrate 31, in which the respective grating regions are alternately positioned such that the polarization directions of the grating regions are different from each other by 180 degrees, and the plurality of electrodes Pₖ₋₁, Pₖ, and Pₖ₊₁ formed on the upper surface and the lower surface of the ferroelectric substrate 31 such that the widths and the lengths of the electrodes are equal to each other, that the electrodes formed on the upper surface of the ferroelectric substrate 31 face the electrodes formed on the lower surface of the ferroelectric substrate 31, and that the polarization directions of the gratings that contact the electrodes Pₖ₋₁, Pₖ, and Pₖ₊₁ change according to the application of the voltage.

In the structure of the spatial light modulation array according to the present invention, the voltage is applied to the electrodes Pₖ₋₁ and Pₖ₊₁. Therefore, the polarization direction of the gratings under the electrodes Pₖ₋₁ and Pₖ₊₁ is controlled, to thus control the refractive indices. Accordingly, the incident laser light is diffracted. The voltage is not applied to the electrode Pₖ. Therefore, the refractive indices are not changed. Accordingly, the irradiated laser goes straight and passes through the ferroelectric substrate 31.

FIG. 6 is a graph showing the distribution of the refractive indices of the light delivered after the voltage is applied to the respective electrodes Pₖ₋₁, Pₖ, and Pₖ₊₁ shown in FIG. 5.

As shown in FIG. 6, the light that passes through the ferroelectric substrate 31 under the electrodes Pₖ₋₁, and Pₖ₊₁ is diffracted due to the periodical refractive indices. The light that passes through the ferroelectric substrate 31 under the electrode Pₖ, to which the voltage is not applied, is delivered without the change in the refractive indices.

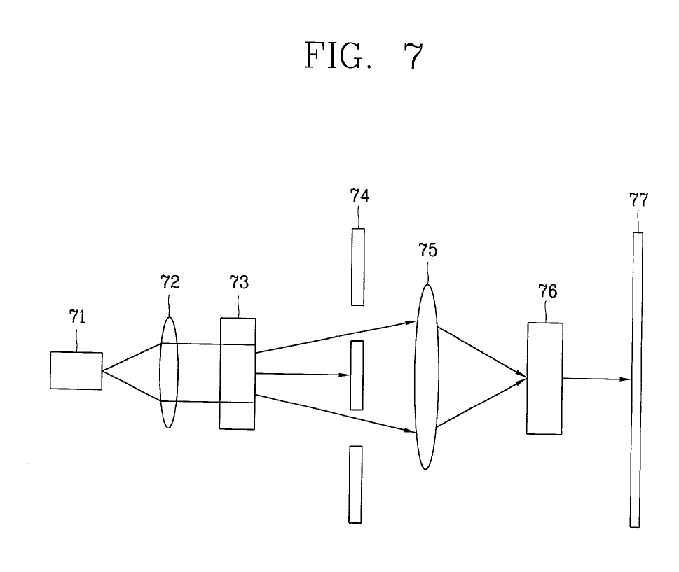

FIG. 7 is a block diagram showing the laser display device using the spatial light modulation array according to the present invention.

As shown in FIG. 7, the laser display device using the spatial light modulation array according to the present invention includes a lens 72 for converting the light oscillated by a light source 71 into a one-dimensional slit beam, a spatial light modulation array 73 for receiving the slit beam applied through the lens 72 and making the slit beam diffracted or go straight through each pixel according to the voltage applied to each electrode, a blocking portion 74 for selectively transmitting some of the light that passes through the spatial light modulation array 73, a condensing lens 75 for condensing the light selected through the blocking portion 74, and a scanner 76 for scanning the condensed light to a screen 77 and displaying a two-dimensional image (beam).

The operation of the laser display device using the spatial light modulation array according to the present invention will now be described in detail.

The laser beam oscillated by the light source 71 passes through the lens 72 and becomes the one-dimensional slit beam. The reason why the laser beam is made the slit beam is because the linear electrooptic effect is largest when the light is incident so as to be perpendicular to the applied electric field due to the characteristic of the spatial light modulation array according to the present invention as shown in FIG. 5.

The spatial light modulation array 73 controls the refractive indices of the incident slit beam by the voltage independently applied to each pixel and delivers the slit beam. That is, the spatial light modulation array 73 diffracts the incident slit beam or makes the incident slit beam go straight by the voltage independently applied to each pixel and delivers the slit beam.

The slit beam that passes through the spatial light modulation array 73 is selectively transmitted through the blocking portion 74 having apertures in specific positions. That is, the diffracted light is transmitted only through the apertures formed in the blocking portion 74 and is blocked in the remaining regions.

The condensing lens 75 that receives the selectively transmitted light through the blocking portion 74 condenses the applied light into the size of a pixel.

The light condensed by the condensing lens 75 is scanned to the screen 77 through the scanner such as the Galvano mirror and displays an image.

The response speed is about several nano seconds because the spatial light modulation array 73 shows the change in the refractive indices due to the electric field. Image can be smoothly displayed on the screen due to the high response speed. Also, mechanical reliability does not deteriorate because the mechanical driving portion does not exist. Accordingly, the reliability of the operation of the spatial light modulation array improves. It is possible to reduce the size of the laser display device because the diffraction angle of the spatial light modulation array becomes relatively larger than in the conventional technology.

As mentioned above, in the spatial light modulation array according to the present invention and the method for manufacturing the same, it is possible to produce the spatial light modulators in large quantities by realizing the spatial light modulator through simple processes, to thus reduce manufacturing expenses of the spatial light modulator.

Also, in the spatial light modulation array according to the present invention and the method for manufacturing the same, it is possible to form the electric field in each pixel formed of several gratings, to thus manufacture the spatial light modulator in the form of the array.

Also, in the spatial light modulation array according to the present invention and the method for manufacturing the same, it is possible to increase the response speed of the spatial light modulator than in the conventional spatial light modulator using the acoustic wave and to enlarge the range of the diffraction angle by performing the modulation due to the electric field unlike in the spatial light modulator using the acoustic wave according to the conventional technology.

Also, in the laser display device using the spatial light modulation array according to the present invention, it is possible to improve the reliability by not installing the mechanical driving portion and to reduce the size of the laser display device by using the spatial light modulation array having the large diffraction angle.

What is claimed is:

1. A spatial light modulation array, comprising:
a ferroelectric substrate divided into a plurality of polarization regions; and
a plurality of electrodes formed on the upper surface and the lower surface of the plurality of polarization regions.

2. The spatial light modulation array of claim 1, wherein the electrode is a pixel electrode.

3. The spatial light modulation array of claim 1, wherein the plurality of electrodes are formed such that the electrodes formed on the upper surface of the plurality of polarization regions face the electrodes formed on the lower surface of the plurality of polarization regions.

4. The spatial light modulation array of claim 1, wherein the plurality of polarization regions are formed such that the polarization regions have a uniform width and the polarization direction of the polarization regions is different from the polarization direction of adjacent polarization regions by 180 degrees.

5. The spatial light modulation array of claim 1, wherein the ferroelectric substrate has spontaneous polarization proceeding from the lower surface of the ferroelectric substrate to the upper surface of the ferroelectric substrate at the temperature no more than the Curie temperature.

6. The spatial light modulation array of claim 1, wherein the plurality of electrodes are formed by depositing a metal on the upper surface and the lower surface of the ferroelectric substrate and patterning the deposited metal.

7. The spatial light modulation array of claim 1, wherein the plurality of electrodes are formed such that the widths and the lengths of the electrodes are equal to each other and that the distances, by which the electrodes are separated from each other, are equal to each other.

8. The spatial light modulation array of claim 1, wherein an electric field is applied to the polarization regions, on which the plurality of electrodes are formed.

9. The spatial light modulation array of claim 1, wherein a plurality of spontaneous polarization regions and a plurality of domain-inverted regions are alternately positioned.

10. The spatial light modulation array of claim 1, wherein the presence of the Bragg gratings is determined by the voltage applied to the electrodes.

11. A method for manufacturing a spatial light array, comprising the steps of:
forming a plurality of electrodes on the upper surface and the lower surface of a ferroelectric substrate, in which spontaneous polarization is formed, such that the electrodes formed on the upper surface of the ferroelectric substrate face the electrodes formed on the lower surface of the ferroelectric substrate;
applying a voltage to the plurality of electrodes and reversing the polarization of the ferroelectric substrate contacting the electrodes; and
removing the electrodes and forming a plurality of electrodes on the upper surface and the lower surface of the ferroelectric substrate such that the electrodes formed on the upper surface of the ferroelectric substrate face the electrodes formed on the lower surface of the ferroelectric substrate.

12. The method of claim 11, wherein the spontaneous polarization precedes from the lower surface of the ferroelectric substrate to the upper surface of the ferroelectric substrate at the temperature no more than the Curie temperature.

13. The method of claim 11, wherein the plurality of electrodes are formed such that the electrodes have a uniform width and that the distances, by which the electrodes are separated from each other, are equal to each other.

14. The method of claim 11, wherein the polarization is reversed by applying the voltage such that the direction of the spontaneous polarization is the same as the direction of the electric field generated by the voltage.

15. A laser display device, comprising:
a lens for converting a laser beam oscillated by a light source into a one-dimensional slit beam;
a spatial light modulation array for determining the diffraction degree of the slit beam according to the voltage applied to the pixel electrodes, diffracting the slit beam, and delivering the slit beam;
a blocking portion for selectively transmitting the diffracted beam;
a condensing lens for condensing the selectively transmitted beam; and
a scanner for scanning the condensed beam to a screen.

16. The laser display device of claim 15, wherein the blocking portion blocks the beam that is not diffracted through the spatial light modulation array and transmitting the beam diffracted through the spatial light modulation array through apertures.

17. The laser display device of claim 15, wherein the scanner is the Galvano mirror.

18. A spatial light modulation array, comprising:
a ferroelectric substrate divided into a plurality of polarization regions that have a uniform width and whose polarization direction is different from the polarization direction of adjacent regions by 180 degrees; and
a plurality of pixel electrodes formed on the upper surface and the lower surface of the plurality of polarization regions such that the pixel electrodes formed on the upper surface face the pixel electrodes formed on the lower surface,
wherein the widths and the lengths of the plurality of pixel electrodes are equal to each other and the distances, by which the pixel electrodes are separated from each other, are equal to each other.

19. The spatial light modulation array of claim 18, wherein the ferroelectric substrate has spontaneous polarization proceeding from the lower surface of the ferroelectric substrate to the upper surface of the ferroelectric substrate at the temperature no more than the Curie temperature.

20. The spatial light modulation array of claim 18, wherein the plurality of pixel electrodes are formed by depositing a metal on the upper surface and the lower surface of the ferroelectric substrate and patterning the deposited metal.

21. The spatial light modulation array of claim 18, wherein the electric field is applied to the polarization regions, on which the plurality of pixel electrodes are formed.

22. The spatial light modulation array of claim 18, wherein a plurality of spontaneous polarization regions and a plurality of domain-inverted regions are alternately positioned.

23. The spatial light modulation array of claim 18, wherein the presence of the Bragg gratings is determined by the voltage applied to the electrodes.

24. A method for manufacturing a spatial light array, comprising the steps of:
forming a plurality of pixel electrodes on the upper surface and the lower surface of a ferroelectric substrate, in which spontaneous polarization is formed from the lower surface to the upper surface at the temperature no more than the Curie temperature, such that the pixel electrodes formed on the upper surface of the ferroelectric substrate face the pixel electrodes formed on the lower surface of the ferroelectric substrate;
applying a voltage to the plurality of pixel electrodes such that the direction of the spontaneous polarization is the same as the direction of the electric field generated by applying the voltage to the plurality of electrodes and reversing the polarization of the ferroelectric substrate contacting the electrodes; and
removing the plurality of pixel electrodes and forming a plurality of pixel electrodes on the upper surface and the lower surface of the plurality of polarization regions such that the pixel electrodes formed on the upper surface of the polarization regions face the pixel electrodes formed on the lower surface of the polarization regions.

25. The method of claim 24, wherein the plurality of pixel electrodes are formed such that the widths of the pixel electrodes are equal to each other and the distances, by which the plurality of pixel electrodes are separated from each other, are equal to each other.
